(19) United States
(12) Patent Application Publication
(10) Pub. No.: US 2004/0103444 A1
(43) Pub. Date: May 27, 2004

(54) Point to multi-point broadcast-quality Internet video broadcasting system with synchronized, simultaneous audience viewing and zero-latency

(76) Inventors: Neal Weinberg, New Rochelle, NY (US); Aryeh Goldsmith, Brooklyn, NY (US)

Correspondence Address: LOTT & FRIEDLAND, P.A., P.O. BOX 141098, CORAL GABLES, FL, 33114-1098, US

(21) Appl. No.: 10/400,245

(22) Filed: Mar. 27, 2003

Related U.S. Application Data
(60) Provisional application No. 60/429,195, filed on Nov. 26, 2002.

(51) Int. Cl. H04N 7/16; H04N 7/173; H04N 7/10; H04N 7/025; H04H 9/00

(52) U.S. Cl. 725/132; 725/34; 725/140

(57) ABSTRACT

An Internet video broadcasting system providing to broadcasters the ability to simultaneously deliver broadcast-quality, multi-media content to large numbers of viewers using the existing Internet infrastructure while retaining control over the exact timing of display of the content to viewers.

### CLAIM OF PRIORITY

This application is a Continuation in Part of provisional application Serial No. 60/429,195 filed on Nov. 26, 2002, herein incorporated by reference.

### TECHNICAL FIELD

The present invention relates generally to the field of computer-based multimedia content distribution, and particularly, to distribution, delivery, and playback of multi-media content over an electronic communications network, such as the Internet, to a plurality of viewers. The present invention fully controls, regulates and synchronizes multimedia content remotely in a simultaneous manner and without latency.

### BACKGROUND OF THE INVENTION

Distribution, delivery and playback of multimedia content over the Internet is currently accomplished through the use of relatively sophisticated software and hardware systems. The field, however, is still in its early stages and development and introduction of new systems is an ongoing process. Detailed information on the nature of such hardware and software systems is widely and publicly available through a growing number of Internet web sites and publications dedicated to the field. These sources of information, and the information they contain, are easily accessible and well known to those skilled in the art relevant to the present invention. For this reason, the present application will not attempt to describe the existing systems in minute detail but rather in general scope sufficient to highlight their shortcomings in relation to the disclosed invention.

Currently, the distribution, delivery, and playback of multi-media content over the Internet continues to grow and develop at a tremendous pace. From the early days of the Internet boom in 1994, corporations and individuals have recognized the great utility of the Internet as a content delivery mechanism. For many, delivery of real-time full motion TV-quality video over the internet is seen as the “holy grail” of mass broadcasting. However, according to Gartner Research, due to inherent limitations of the Internet's architecture, true TV-quality video over the Internet will not be possible for three to five years using existing technology.

Existing Internet multimedia content delivery systems can generally be divided into two categories: file transfer systems and streaming systems. File transfer systems have been around since the inception of the Internet but are rarely used today because of inherent limitations which are discussed below. File transfer systems simply make available for download computer files in a known format which can be played back by the user at a local computer using a content “player”. File transfer systems generally rely on a file server from which users can download the multimedia files in a variety of well known ways such as File Transfer Protocol (“FTP”), Hyper-Text Transfer Protocol (“HTTP”) or Network News Transfer Protocol (“NNTP”). Multimedia files are generally transmitted in formats defined by standards groups such as the Moving Pictures Expert Group (“MPEG”), the World Wide Web Consortium (“W3C”), or by private corporations, such as Microsoft or Adobe, which have achieved such a level of market saturation that they have become de facto standards.

Generally speaking, however, all file transfer systems share the same characteristics. Specifically, with a file transfer system, the transfer of the multimedia content, and the viewing of the content involve two separate and independent steps which must be performed in sequence. First, the user must download a file in its entirety, and then the user may view the content using a separate application which can decode and display the content in the format it was received. The principal advantage of file transfer systems is that the actual viewing of the content is done locally or “offline”, independent of a user's online connection, which means that there is no need to be concerned with the reliability of the network through which the file is transmitted since the network is not used during playback.

The disadvantages of file transfer systems, however, are numerous and in many respects outweigh any possible advantages. In the first place, using a file transfer system can be a disjointed and unsatisfying experience for the viewer. This is because the user must first initiate a transfer, wait until the entire transfer is complete and only then can he or she view the content. Because multimedia files tend to be massive, and most consumer connections to the Internet are of the slow dial-up variety, downloading multimedia files, even a short one, can usually take hours and sometimes more than a day. Such long delays between downloading and viewing of content act as a very large disincentive for the user and essentially rule out file transfer systems for the delivery of time-sensitive content such as news programming.

From the standpoint of the broadcaster of content, file transfer systems are disadvantageous for several reasons. First, because the viewing of the content occurs offline, the broadcaster has no control over when the content is viewed by the end user. That is, a user may download content today and not view it for days or weeks. Control over the timing of viewing of the content is important for broadcasters who are interested in reproducing on the user's computer the massive “shared viewing experience” which right now only television can deliver.

In addition, file transfer systems can tremendously tax a broadcaster's delivery infrastructure since they are “bandwidth-hungry” by definition. A broadcaster that makes available content which it expects will be downloaded by millions of people must either make a tremendous investment in computer hardware and available bandwidth, or be prepared to face a negative response and ill-will from the hundreds of thousands who are unable to download the content due to network congestion.

To overcome many of the low bandwidth issues making the delivering of large files very time-consuming, online broadcasters can compress files to smaller sizes and, theoretically, at least, reduce transmission times. However, the compression of files can seriously degrade the quality of their content beyond what is acceptable to most viewers. Moreover, the higher compression ratios can reach a level of diminishing returns where the processing “overhead” necessary to compress and decompress files can eliminate the benefits gained in the reduction of file sizes.

Streaming, the second category of systems, relies on the transmission of small bits of data that are assembled at the viewer's computer and played back in sequence. Streaming systems, as the name implies, manipulates “stream” of data on the fly and displays it to the user in near real-time. Streaming applications receive data in the background, briefly store, or “buffer” it in small increments and then immediately display it to the user. As data is being displayed to the user in the “foreground”, the streaming application is receiving and buffering new data in the “background”. The most common streaming systems in use today are called RealMedia (developed by RealNetworks Corp.) and Windows Media (developed by Microsoft Corp.)

In order to understand how streaming works, and what its disadvantages are, it is necessary to understand how a data file is transmitted on the Internet using the default TCP/IP protocol. In a nutshell, TCP/IP initially breaks up the data file into relatively small “chunks”, referred to as packets, and encloses each packet into a data “envelope”. The data envelope contains, among other information, the origin and destination address for the packet as well as sequence information which is used to assemble all packets at the destination in the correct order.

The individual packets of the data file are then independently transmitted through a series of network nodes, also called “routers”, until they arrive at the destination address. Because the packets are sent independently and there are thousands of possible paths between the origin and destination addresses, it is almost always the case that packets arrive at the destination out of sequence. It is also usual for packets to get “lost” during transmission, in which case the computer at the destination end must request that they be retransmitted. Once the destination computer has received all of the packets, they are stripped of the envelope data and reassembled to create a copy of the original file.

The operations involved in creation of packets, re-transmission of packets, and their re-assembly at the destination, introduce a time delay which is commonly referred to as “latency.” Whenever a network is congested, packets require longer and more diverse routings, more packets are lost and re-transmitted, and more packets are likely to arrive out of sequence. Thus, a congested network has higher latency and is perceived as “slower” by the user than one which is not congested.

The TCP/IP packet routing scheme is very effective for the transmission of asynchronous data, such as text and binary files, which does not require immediate display at the destination. However, in streaming applications, the goal is to display data as soon as it arrives. Clearly, it is not acceptable for a streaming application to display multimedia data in the incorrect sequence and therefore some assembly of the data, and thus some latency, is a necessary aspect of streaming applications which operate over the internet. Unfortunately, even a small amount of latency is enough to severely degrade the quality of streamed media.

In order to eliminate or reduce latency to acceptable levels, streaming applications attempt to create a “live, real-time session” between the server which is streaming the content and each client computer which receives the content. The direct connection ensures that all packets transmitted by the server arrive in the correct sequence, thus eliminating, or at least greatly reducing, latency.

However, the great disadvantage of streaming systems is that the number of live sessions that a server can handle is limited in direct proportion to the bandwidth necessary to transmit the data streams and the server's capability to continuously reserve these open, live sessions. What that means is that the higher the quality of the multimedia content which is streamed to client computers, the lower the number of viewers who can simultaneously receive the stream. The only way to alleviate this problem, at present, is to increase the bandwidth available at both the receiving and sending end, to create enhanced networks which handle data transfers more efficiently, or to simply add redundant content servers and more data connections.

While existing streaming media systems from RealNetworks and Microsoft have made some improvements in the efficiency of data transfer, and therefore in picture and sound quality, they are still plagued by the problems inherent to the Internet's architecture. To make matters worse, it does not appear that the availability of higher bandwidth available through broadband connections is propagating at the rate previously anticipated by content providers. Published projections from telecommunications providers indicate that by 2004, fewer than half of all households in the United States will have broadband connections. Even when broadband is more available and more affordable, the very architecture of Internet technology for simultaneous, full motion, real-time, television quality online video quality, under technologies now existing and being deployed, will remain a goal and not a reality.

AOL Time Warner has been attempting to create supercharged networks of Internet routers capable of moving large media files far more efficiently than is possible with current Internet technology. As reported by The New York Times on Nov. 4, 2002, AOL Time Warner's Ultravox system is a combination of file formats and supporting switching hardware. However, even this system only allows for 10,000 simultaneous users to be supported by one server. While this is an improvement over the 100 to 1,000 simultaneous users supported by currently available servers from Sun Microsystems and Microsoft, 10,000 simultaneous connections per server is still very limiting.

Ultravox is just one strand in a widespread effort to bring badly needed improvements to Internet video and audio. Despite years of evolution for streaming systems, streaming costs remain too high for many would-be providers while quality is still too low to create a mass audience for commercial, Internet-powered entertainment services conceived by media giants such as AOL Time Warner, Sony and Disney.

Companies such as SockEye Networks, InterNap and Edgestream offer intelligent routing services that also attempt to alleviate data congestion problems that can frequently degrade the quality of live strearning broadcasts over the Internet. Both Microsoft and RealNetworks have attempted to release improvements in their software technology aimed at further reducing latency. RealNetworks and Microsoft have also launched new software initiatives, client side products, called TrueStream and Corona respectively, which attempt to make playback more stable.

In addition to the foregoing, previous attempts at methods for distribution, playback and streaming video schemes, and related technologies, are described in U.S. Pat. No. 6,536,043 to Guedalia, U.S. Pat. No. 6,510,556 to Kusaba et al., U.S. Pat. No. 6,463,468 to Buch et al., U.S. Pat. No. 6,434,622 to Monteiro et al., U.S. Pat. No. 6,389,473 to Carmel et al., U.S. Pat. No. 6,370,688 to Hejna, Jr., U.S. Pat. No. 6,351,474 to Robinett et al., U.S. Pat. No. 6,317,780 to Cohn et al., U.S. Pat. No. 6,317,791 to Cohn et al., U.S. Pat. No. 6,304,852 to Loncteaux, U.S. Pat. No. 6,298,373 to Burns et al., U.S. Pat. No. 5,956,716 to Kenner et al., U.S. Pat. No. 5,883,901 to Chiu et al., U.S. Pat. No. 5,761,417 to Henley et al., and U.S. Pat. No. 5,751,968 to Cohen.

However, all of these methods for distribution, playback and streaming video schemes have failed to date to solve the inherent problems in the Internet's TCP/IP network architecture. And this structural fact will continue to plague all of these ongoing efforts. So called one-to-one networks such as the Internet which require a direct and continuously open connection, or a live, real-time session, between client and server, as streaming systems demand, will fail to deliver if challenged by enough simultaneous users. Achieving a truly “shared viewing experience” online by delivering then simultaneously displaying to all properly equipped viewers, broadcast quality, multimedia programming content at precisely the same time over the Internet has not been possible to date. Bandwidth issues and the very design of Internet architecture have precluded this from occurring and they will continue doing so under the current architecture now available.

Accordingly, there is a need in the art for a system which provides broadcasters the ability to simultaneously deliver broadcast-quality, multimedia content to millions of viewers using the existing Internet infrastructure while retaining control over the exact timing of display of the content to viewers.

There is a further need in the art for a system capable of delivering full-motion video, rich audio, and interactive content such as HTML over the Internet with zero viewing playback latency to a widespread audience far exceeding the capacity of existing systems.

There is a further need in the art for a multimedia viewing system which uses the Internet as its principal delivery method and closely approximates the “shared viewing experience” provided by television today.

There is a further need in the art for a multimedia viewing and delivery system that merges the best of the television viewing experience with the two-way communications capabilities of the PC and the Internet and allows a simultaneous viewing experience across the web absent of the several limitations current existing today and projected to exist for years to come.

### SUMMARY OF THE INVENTION

The present invention overcomes these and other disadvantages of existing technologies by providing a system which takes advantage of all the benefits of file transfer and streaming systems and combines them into a multimedia delivery mechanism capable of delivering a television-like “shared viewing experience” without relying on real-time or near-real-time transmissions which are unfeasible in today's Internet.

The present invention in its preferred embodiment, consists of a computer-based multimedia content delivery, distribution and playback system comprising a plurality of viewers each equipped with a client computer; an instruction file server computer operated by a broadcaster; a content file server computer; a software client application residing within, and capable of controlling, each of the client computers; an instructions database accessible to the instruction file server computer; and a content database accessible to the content file server computer; wherein the client computers, the instruction file server computer, and the content file server computer are capable of communicating instructions and transmitting data to each other through an electronic communications network; wherein the broadcaster selects a content file for delivery to one or more target viewers, from among the plurality of viewers, and for display of the content file on each of the target viewers' client computer; wherein the instruction file server computer retrieves an instruction set from the instruction database corresponding to each the selected content file and transmits the instruction set to each of the target viewers' client computer for use by the software client application; wherein the software client application communicates with the video file server computer in accordance with the instruction set and requests transmission of the content file to each of the target viewers' client computer; wherein the video file server computer retrieves the content file from the content database and transmits the content file to each of the target viewers' client computer; wherein the software client application directs the client computer where it resides to display the content file in accordance with the instruction set; and wherein the content file is displayed to a target viewer at the client computer in accordance with the instruction set.

An alternative embodiment of the present invention comprises a computer-based multimedia content delivery, distribution and playback system comprising a plurality of viewers each equipped with a client computer; an instruction file server computer operated by a broadcaster; a content file server computer; a, software client application residing within, and capable of controlling, each of the client computers; an instructions database accessible to the instruction file server computer; and a content database accessible to the content file server computer; wherein the client computers, the instruction file server computer, and the content file server computer are capable of communicating instructions and transmitting data to each other through an electronic communications network; wherein the broadcaster, through the software client application, makes available for display to the viewers one or more content files and wherein one or more target viewers, from among the plurality of viewers, through the software client application, selects one or more of the content files for display on each of the target viewers' client computer; wherein the instruction file server computer retrieves an instruction set from the instruction database corresponding to each the selected content file and transmits the instruction set to each of the target viewers' client computer for use by the software client application; wherein the software client application communicates with the video file server computer in accordance with the instruction set and requests transmission of the content file to each of the target viewers' client computer; wherein the video file server computer retrieves the content file from the content database and transmits the content file to each of the target viewers' client computer; wherein the software client application directs the client computer where it resides to display the content file in accordance with the instruction set; and wherein the content file is displayed to a target viewer at the client computer in accordance with the instruction set.

The system of the present invention generally provides for the following components: (1) client software to be installed in the viewer's PC; (2) a server to deliver instructions to the client software and thus control its entire operation on the viewer's PC; and (3) a content server to store and deliver multimedia content to the client software in accordance with the aforementioned instructions.

Briefly stated, the system functions as follows: The user installs the client software on his or her PC and the software client in turn communicates with the broadcaster's instruction server through the internet. The instruction server transmits commands to the client software which in turn control the operation of the client software. The instructions include the exact multimedia files which are to be downloaded to the client software, the time when such downloads will occur, and the exact times when the downloaded content is to be displayed to the viewer.

The client is instructed to download content in advance of the time when the content is to be shown. The download operations, however, occur in the background, without the user's intervention, and, generally, without the user's knowledge as to what is being downloaded or when. The client application automatically detects the user's Internet connection speed and then, based on this speed, calculates an acceptable percentage of the user's bandwidth to utilize in order to deliver the content in the least intrusive manner. This allows the user's online experience to remain virtually unaltered. It is envisioned that download operations for the multitude of users of the system will be spread over a timeline that is calculated in real-time in order to avoid network congestion and thus facilitate speedy downloads.

At the time specified in the download instructions, a download instruction is triggered within the client software. The client software then transmits a download request to a content server which then begins transmitting the requested content to the client PC. Once fully downloaded, the multimedia content is stored on the viewer's PC, in an encrypted fashion if the broadcaster so desires, and will only be shown to the user when directed by a display instruction from the client software. This display instruction is sent by the instruction server to the client software which, in turn, triggers the display instruction and displays the multimedia content. Again, the delivery and storage of the content is absolutely transparent to the viewer who may not even be aware that any content has been downloaded or stored on his or her computer. Finally, at the time specified in the display instructions, the downloaded content is displayed on the user's PC by the software client. In the preferred embodiment of the present invention, the Software Client initiates whichever default media player the user has installed on his or her PC, such as the Quicktime player, Real Player or Windows Media Player, and plays back the downloaded content through this player.

The download and display instructions are coordinated between the multitude of users of the system and the instructions server so that downloads are spread over a period of time but the actual display of the content occurs at the exact same time for all viewers. Thus, for example, if 10,000 viewers are using the system to view a particular multi-media presentation scheduled to be shown on a Friday, at 21:47:06 Greenwich Mean Time (“GMT”), the download instructions for the 10,000 separate downloads of the content are delivered in varying bite size “chunks” based on each user's connection capabilities and may be spread apart over a period of days, say from Monday to Thursday, as determined by the software client, or alternatively by the instruction server, the so that all of the viewers will not try to download the content simultaneously. The downloads, however, will be scheduled so that all viewers are assured to have downloaded the content by the time it is scheduled to be displayed. In order to fully achieve the shared viewing experience, all 10,000 users will have received a display instruction which will trigger their client to show the multimedia presentation at the same exact time, preferably based on GMT to compensate for time zone variations. Once the time for the display instruction is reached, the multimedia content is simultaneously displayed to all 10,000 viewers thus creating a shared viewing experience very similar to a TV broadcast.

Accordingly, it is an object of the present invention to provide a system which provides broadcasters the ability to simultaneously deliver broadcast-quality, multimedia content to millions of viewers using the existing Internet infrastructure while retaining control over the exact timing of display of the content to viewers.

It is a further object of the invention to provide broadcasters with a system capable of delivering full-motion video, rich audio and interactive content such as HTML over the Internet with zero viewing playback latency to a widespread audience far exceeding the capacity of existing systems.

It is a further object of the present invention to provide to viewers a multimedia viewing system which uses the Internet as its principal delivery method and closely approximates the “shared viewing experience” provided by television today.

It is yet a further object of the present invention to provide a multimedia viewing and delivery system that merges the best of the television viewing experience with the two-way communications capabilities of the PC and the Internet and allows a simultaneous viewing experience across the web absent of the several limitations current existing today and projected to exist for years to come.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is schematic diagram depicting the hardware and software components present in a preferred embodiment of the present invention and their various connections and relationships.

### DESCRIPTION OF THE PREFERRED EMBODIMENTS

1. Hardware and Software Components of the Invention

The system of the present invention utilizes three separate hardware components. The first hardware component is the viewer's PC. The viewer's PC must be equipped with communications hardware, such as a modem or network adapter, sufficient to allow continuous or regular access to the Internet. The second hardware component is a computer instruction server operated by the broadcaster. The instruction server is similarly equipped with hardware allowing it to communicate with the viewer's PC through the Internet. The final hardware component is a content server, also operated by the broadcaster which is also equipped with Internet connectivity hardware.

It is envisioned that in the preferred embodiment of the present invention, there will be a multitude, perhaps millions, of viewer PCs and several content and instruction servers.

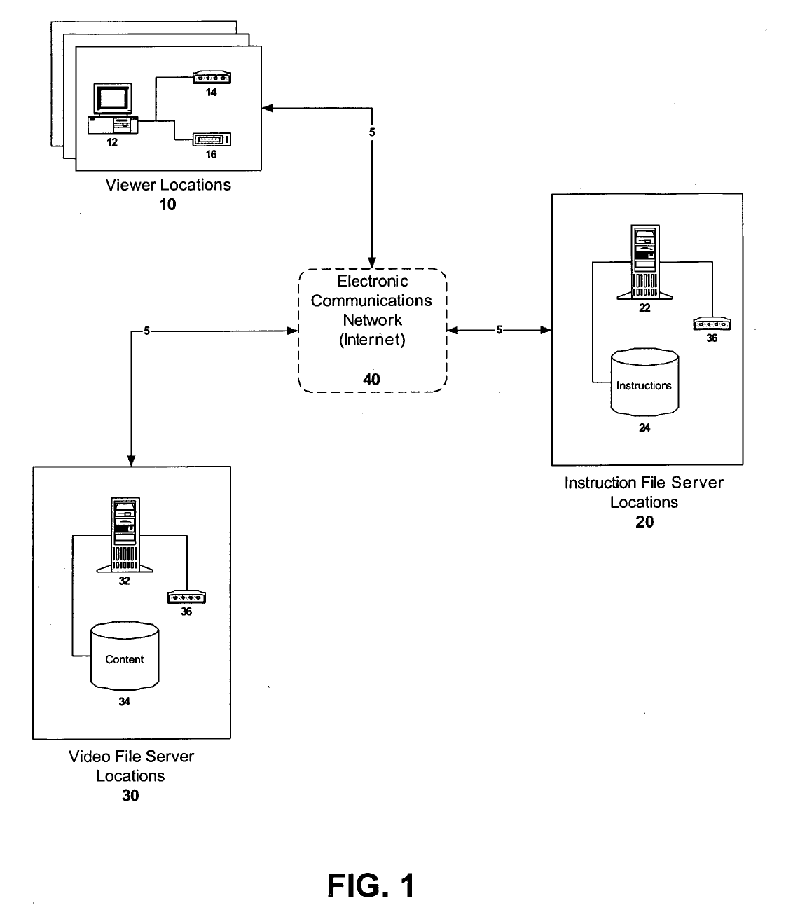

FIG. 1 is schematic diagram depicting the hardware and software components present in a preferred embodiment of the present invention. It should be understood that although in the preferred embodiment, there can be millions of viewer PCs connected to multiple Instruction and Video File Servers, for ease of illustration, a system with only three viewer PCs and single servers of each type is shown. Each viewer location 10 is equipped with a viewer PC 12 which, in turn, is connected, either internally or externally, to a storage system 16 and to telecommunications hardware 14 such as a modem or a network adapter. Each Instruction Server location 20 is equipped with an Instruction Server 22 which, in turn, is connected, either internally or externally, to an instructions database 24 and to telecommunications hardware 26 such as a modem or a network adapter. Video File Server location 30 is equipped with a Video File Server 32 which, in turn, is connected, either internally or externally, to an instructions database 34 and to telecommunications hardware 36 such as a modem or a network adapter. The Viewer Location 10, Video File Server Location 30, and Instruction Server Location 20, can receive and transmit data to each other via the Internet 40 by means of standard internet connections 5.

The Instructions Server 22 is where the actual instructions are stored, modified, controlled and delivered or “broadcast” from in order to reach the viewer PCs 12. The Software Client follows these instructions and automatically requests the instructed video content from the Video File Server 32. The instructions contain information such as the particular video content that should be downloaded, at what interval and when exactly the video content should be played back.

With regard to software, in addition to basic server and client operating systems, the viewer's PC is equipped with a client software application customized for the present invention. The computer instruction server is also equipped with customized software capable of communicating, over the Internet or a similar digital telecommunications network, with the viewer's PC and of transmitting instructions to the client software application residing therein. The content server is equipped with software capable of accepting instructions from the client application, and of downloading content files to the viewer's PC in accordance with those instructions.

The client software application is responsible for coordinating the download, assembly and playback of content on the viewer's PC. The client software also is responsible for detecting the PC user's connection speed and based on this, determining exactly how to then request and receive as it relates to speed and file sizes the video content from the content server. This latter task may, alternatively, be performed by the computer instruction server.

2. Operation of the Invention

The system of the present invention requires viewers to install a client software program on their PCs (hereinafter the “Client Software”). The Client Software, once installed and resident on the viewer's PC, communicates through the Internet with a servers maintained by the broadcaster. In the preferred embodiment of the present invention, the broadcaster, much like a TV broadcaster, is in full control of the content. The broadcaster remotely controls when and how the viewer receives and experiences the video and multimedia content. Thus, just as the TV viewer decides to have their TV turned on and then receives video broadcasts controlled by the broadcaster and received by the TV, so too, by using the system of the present invention, does the PC user decide to have their PC turned on and therefore receives video and multi-media content that is controlled by the broadcaster and received and managed precisely for simultaneously timed and viewed broadcasts through the Client Software.

The broadcaster operates two different types of servers: “Instruction Servers” and “Video File Servers”. The Instruction Server is used to provide instructions directing the Software Client to download and play content with precise specificity as it relates to both the manner in which video and multimedia are downloaded and then played back or “broadcasted” to the viewer. The Video File Server is used to store the actual content to be delivered to the viewer's PC. Upon installation on the viewer's PC, the Software Client communicates through the Internet with an Instructions Server. The Instructions Server, in turn, sends instruction directives to the Software Client. The instructions sent by the Instruction Server detail exactly which video content the Software Client is authorized to request and receive from the Video File Server. The instructions may also indicate when the Software Client may make a request for download from the Video File Server.

The Video File Server contains the particular multimedia content files, which can, upon a request from the Software Client be downloaded to the viewer's PC. Upon receipt of a download request, the Video File Server confirms that the request is authentic and, if it is, begins transmitting the requested content to the viewer's PC. As content files are received at the viewer's PC, the Software Client stores the files using the default file storage hardware of the viewer's PC. The files remain in storage, encrypted if the broadcaster so desires, in the viewer's PC until the time they are scheduled for display.

The Video File Server delivers content files in a methodology predetermined by the instructions from the Instruction Server which are relayed by the Software Client. That is, the instructions will

The Video File Server delivers content files that are summoned by the Software Client application in a methodology optimized in real time based on the user PC's connection speed, processing power and available bandwidth. The software client will, based on this real time information, specify the size of the files, the rate at which they are delivered and over what period of time the delivery takes place. Data is then sent in certain byte size “chunks” based upon the individual user's connection type and speed. The Software Client application also communicates with the Video File Server to request content based upon the chosen audience composition. This system operates 24 hours per day during which time the Video File Servers can silently and remotely deliver broadcast-quality video content to the millions of viewer PCs in which the Software Client application resides.

The system repeats this continuously to the millions of viewers throughout the world who have installed the Software Client on their PCs The system can deliver these videos to this entire user base or to a subset of its user base based on certain demographics, psychographics, Internet usage patterns and other defining audience characteristics that the system is capable of measuring.

This full-motion, broadcast quality, multimedia video content is then directed, controlled and precisely synchronized by the millions of installed Software Clients. Based upon the broadcast display instructions, or “play codes”, transmitted by the Instructions Server, all video can be viewed simultaneously by the entire user base or by that subset of the user base that has been selected by the broadcaster.

In this way, a simultaneously broadcasted video playback environment is achieved through the system's servers by controlling the broadcast instructions sent to the Software Client. The system's Instruction Server remotely broadcasts play codes to all Software Clients. These play codes are included in the instructions sent by the Instructions Server, are transmitted either prior, during or after full-motion video content and any accompanying HTML documents content are delivered to the Software Clients. These play codes instruct Software Clients to select the previously delivered content files to then play simultaneously on all viewers' PCs, at the exact same hour, minute and second. The instructions may be to only play certain video content to certain users or to play video content to the entire user base.

Further, the play codes can instruct Software Clients to operate based on one global time or in accordance with local time zones. The system of the present invention utilizes UTC, also called Coordinated Universal Time, and popularly known as GMT (Greenwich Mean Time), or Zulu time. The timing clock for the present invention calculates the time since the Epoch, as the number of seconds since 00:00:00 UTC January 1. The millions of Software Clients synchronize with the system's servers to precisely time all instructed events. Identical video content may play globally or each country may receive a localized version in its native language. Regardless of the particulars of the instructions, the video play is uninterrupted, precise and simultaneous.

In cases where the Instructions Server has been programmed to deliver its play codes to the Software Clients prior to the set time of video play, it is not necessary for the user's PC to even be online at the time of playback. The content will still play at the set time, in a synchronized fashion so long as the users PC is on. In addition to the immediate benefit of having the user's connection speed decoupled from the level of user experience (i.e., the high quality level of the content) the system of the present invention gives broadcasters the ability to provide, and viewers the ability to enjoy, a simultaneously “shared viewing experience” much like that which is enjoyed by television viewers.

Having described in detail the operation of the present invention, the following paragraphs include further detailed disclosure regarding features of the invention.

a. Software Client Functions:

The Software Client application is a send and receive data daemon (i.e., an application that is always on, constantly active, generally as a background task, and has the ability to monitor and act upon processes) that plays the video content on the client's PC at a specified time, based on the instructions sent by the Instructions Server. This daemon controls the actual initiation of the “play code” that is sent by the Instruction Server, thereby initializing all processes to play the intended video content. The daemon also controls the synchronization between the viewer's PC clock and the Instructions Server timing clock, thereby assuring synchronous play on PCs running the Software Client. Synchronization of the PC and Instructions Server can be accomplished in a number of ways well known in the art. For example, synchronicity between the PC and Instructions Server can be ensured by requiring both the Instructions Server and the PC to synchronize their respective clocks to a trusted time source, such as the United States Naval Observatory, using a Network Time Protocol (NTP) client. Alternatively, Instructions Server can act as the trusted time source and act as an NTP time server itself to which the PC can synchronize using an NTP client. NTP is a standard open internet protocol which enables client computers to maintain system time synchronization to the United States Naval Observatory master atomic clocks in Washington, D.C. and Colorado Springs, Colo.

It should be pointed here that, as used in this specification and the claims, the action of “synchronizing” or “synchronization” with reference to the internal clocks of the various computers involved, does not necessarily involve a change or re-setting of the internal clock of the relevant computers but could simply mean the measurement of a time differential between the internal clocks and the trusted time source and use of such differential to establish an accurate and trusted time reference.

The video content may be accompanied by a mini-web site to add additional content, web links, flash animations and other interactivity to the video presentation. This mini-web site is compressed, and the Software Client is also capable of receiving this content from the Video File Server. The Software Client can then queue this additional content, along with the video content, for display.

The mini-web site, which can be comprised of standard HTML, web based content, if included, appears to the viewer once the broadcast-quality video content has been completed playing. Any video content data may be delivered such as MPEG 4 broadcast video which incorporates all types of layered multimedia content within the actual video data.

The Software Client queries, and receives instructions, from the Instructions Server. These instructions detail the exact video content that should be downloaded to the viewer's PC. The Software Client determines how the contents should be downloaded—meaning, over what period of time and in what file size “chunks” (e.g., 20 k of data at a time over 5 days). The Software Client then assembles the file chunks into a complete video content file, ready for playback. In an alternative embodiment, the way in which the content is downloaded (i.e., file size chunks and time spread) can be dictated by the Instruction Server and such information can be incorporated into the instructions transmitted to the Software Client.

Also important to the successful operation of this system is the ability for the Software Client to receive instructions regarding when it should receive new instructions from the Instructions Server and at what intervals it should query the Instructions Server for new instructions.

b. Broadcasting “Play Codes” from the Instructions Server:

The Software Client receives separate lines of instructions from the Instructions Server for the video playback. These “play codes” detail exactly when the video should be shown and to what exact audience either to the entire audience or to a specific subset of the audience. Regardless of the audience, all those that are targeted to view the broadcast-quality video content playback do so simultaneously. This simultaneous viewing can also be instructed to occur to a large subset, by region of the world, by operating system type, by language, by time zone or other defining parameters—all of which are monitored by the Software Client.

c. Downloading Broadcast-Quality Video Content from the Video File Server:

The Software Client captures the above-mentioned PC-specific information and based on these parameters, and in concert with the instructions from the Instructions Server, the Software Client retrieves the proper information from the Video File Server. The Video File Server has all relevant broadcast-quality video content stored in the relevant directory structures that are properly recognized by the Software Client

d. Timing Synchronization Mechanisms:

The Software Client contains programming that implements the timing synchronization functions of the present invention. These functions enable the Software Client to synchronize the clock of the PC it resides in with the time of the Instruction Server. The Software Client regularly communicates with the Instruction Server to synchronize time. As discussed previously, and by way of non-limiting examples, synchronization of the PC and Instructions Server can be accomplished synchronizing the clock in each to a trusted time source, such as the United States Naval Observatory, using a Network Time Protocol (NTP) client. Alternatively, Instructions Server can act as the trusted time source and act as an NTP time server itself to which the PC can synchronize using an NTP client.

Clock synchronization insures that all Software Clients can play back the intended content at precisely the same time. The system of the present invention accomplishes this by utilizing a common recognized time zone as a reference for the client and servers. In the preferred embodiment, the common recognized time zone is Coordinated Universal Time (UTC) also popularly known as GMT (Greenwich Mean Time), or Zulu time. The Software Client synchronizes its clock by comparing the Instructions Server's clock against the internal clock of the host PC and making adjustments if necessary. Alternatively, the Software Client can synchronize its clock by comparing the internal clock of the host PC with a trusted time source, such as the United States Naval Observatory, and making adjustments if necessary. This online synchronization can be accomplished in a number of ways well known in the art, such as, for example, by utilizing an NTP client.

The multitude of Software Clients synchronizes with the Instruction Server utilizing this method in order to precisely coordinate time between all instructed events among all Software Clients.

e. The Software Client Download Resumption Capability:

The Software Client also has the capacity to monitor the progression of downloading for a particular file (i.e., the percentage of a file which has been successfully downloaded). If the Software Client has only completed 10% of a file download and something happens to disrupt the connection between the viewer's PC and the Video File Server, the Software Client monitors and manages this. When a connection between the viewer's PC and the Video File Server is re-established, the Software Client resumes downloading the file exactly where it previously was discontinued. This cycle continues until the video content file has been completely downloaded.

3. Alternate Embodiments

The preceding section discloses the preferred embodiment of the present invention. However, many variations on the preferred embodiment are possible and the preferred embodiment is presented for illustrative purposes only.

Accordingly, it will be understood that the preferred embodiments of the invention have been disclosed by way of example and that other modifications and alterations may occur to those skilled in the art without departing from the scope and spirit of the appended claims.

What is claimed is:

1. A computer-based multimedia content delivery, distribution and playback system comprising:
a plurality of viewers, each equipped with a client computer;
an instruction file server computer, operated by a broadcaster;
a content file server computer;
a software client application residing within, and capable of controlling, each of said client computers;
an instructions database accessible to said instruction file server computer; and
a content database accessible to said content file server computer.

2. The system of claim 1 wherein said client computers, said instruction file server computer, and said content file server computer are capable of communicating instructions and transmitting data to each other through an electronic communications network.

3. The system of claim 2 wherein said broadcaster selects a content file for delivery to one or more target viewers, from among said plurality of viewers, and for display of said content file on each of said target viewers' client computer.

4. The system of claim 3 wherein said instruction file server computer retrieves an instruction set from said instruction database corresponding to each said selected content file and transmits said instruction set to each of said target viewers' client computer for use by said software client application.

5. The system of claim 4 wherein said software client application communicates with said video file server computer in accordance with said instruction set and requests transmission of said content file to each of said target viewers' client computer.

6. The system of claim 5 wherein said video file server computer retrieves said content file from said content database and transmits said content file to each of said target viewers' client computer.

7. The system of claim 6 wherein said software client application directs the client computer where it resides to display said content file in accordance with said instruction set.

8. The system of claim 7 wherein said content file is displayed to a target viewer at said client computer in accordance with said instruction set.

9. The system of claim 8 wherein said client computers are personal computers (PCs)

10. The system of claim 8 wherein said electronic communications network is the Internet.

11. The system of claim 8 wherein said content file comprises text, video, audio, HTML, or a combination thereof.

12. The system of claim 8 wherein said instruction set includes the exact playback time and date.

13. The system of claim 12 wherein the internal clock of each of said target viewers' client computer is synchronized to a trusted time and date source.

14. The system of claim 13 wherein said exact playback time and date is expressed in relation to a common recognized time zone.

15. The system of claim 14 wherein said common recognized time zone is Greenwich Mean Time (GMT).

16. The system of claim 13 wherein said trusted time and date source is an atomic clock maintained by the United States Naval Observatory.

17. The system of claim 13 wherein said trusted time and date source is the internal clock of said instruction file server computer.

18. The system of claim 8 wherein said content file is divided into two or more file segments prior to transmission from said content file server computer to each of said target viewers' client computer and is reassembled upon receipt at said client computer.

19. The system of claim 18 wherein the number and size of said file segments is based on a combination of factors selected from the group of factors consisting of: bandwidth available to said client computer, processing capabilities of said client computer, size of said content file and the level of traffic on said electronic communications network.

20. The system of claim 8 wherein said transmission of said content file server computer to each of said target viewers' client computer takes place asynchronously over a set time period.

21. The system of claim 20 wherein said set time period is based on a combination of factors selected from the group of factors consisting of: bandwidth available to said client computer, processing capabilities of said client computer, size of said content file and the level of traffic on said electronic communications network.

22. The system of claim 8 wherein said content file is displayed to said viewer at each of said target viewers' client computer by means of a pre-installed software application compatible with said content file.

23. The system of claim 22 wherein said pre-installed software application is an application selected from the group consisting of: a word processor, a picture viewer, a web browser, a text file viewer, a multimedia player, an mp3 player, a streaming audio player and a streaming video player.

24. The system of claim 8 wherein said content file is stored at each of said target viewers' client computer in an encrypted format.

25. The system of claim 8 wherein said content file is automatically erased from each of said target viewers' client computer after playback.

26. The system of claim 12 wherein:
said exact playback time and date is identical for two or more of said target viewers; and
the internal clock of said two or more target viewer's client computers is synchronized with that of a trusted time and date source;
so that said content file is played back simultaneously at said exact time and date to said two or more target viewers.

27. The system of claim 8 wherein said one or more target viewers is selected from among said plurality of viewers on the basis of demographic factors.

28. The system of claim 27 wherein said demographic factors are selected from the group of factors consisting of: age, geographic location, income, race, gender, occupation, language spoken, ethnic group and internet usage patterns.

29. A computer-based multimedia content delivery, distribution and playback system comprising:
a plurality of viewers each equipped with a client computer;
an instruction file server computer operated by a broadcaster;
a content file server computer;
a software client application residing within, and capable of controlling, each of said client computers;
an instructions database accessible to said instruction file server computer; and
a content database accessible to said content file server computer.

30. The system of claim 29 wherein said client computers, said instruction file server computer, and said content file server computer are capable of communicating instructions and transmitting data to each other through an electronic communications network.

31. The system of claim 30 wherein said broadcaster, through said software client application, makes available for display to said viewers one or more content files and wherein one or more target viewers, from among said plurality of viewers, through said software client application, selects one or more of said content files for display on each of said target viewers' client computer.

32. The system of claim 31 wherein said instruction file server computer retrieves an instruction set from said instruction database corresponding to each said selected content file and transmits said instruction set to each of said target viewers' client computer for use by said software client application.

33. The system of claim 32 wherein said software client application communicates with said video file server computer in accordance with said instruction set and requests transmission of said content file to each of said target viewers' client computer.

34. The system of claim 33 wherein said video file server computer retrieves said content file from said content database and transmits said content file to each of said target viewers' client computer.

35. The system of claim 34 wherein said software client application directs the client computer where it resides to display said content file in accordance with said instruction set.

36. The system of claim 35 wherein said content file is displayed to a target viewer at said client computer in accordance with said instruction set.

37. The computer-based multimedia content delivery, distribution and playback system of claim 36 wherein said client computers are personal computers (PCs)

38. The system of claim 36 wherein said electronic communications network is the Internet.

39. The system of claim 36 wherein said content file comprises text, video, audio, HTML, or a combination thereof.

40. The system of claim 36 wherein said instruction set includes the exact playback time and date.

41. The system of claim 40 wherein the internal clock of each of said target viewers' client computer is synchronized to a trusted time and date source.

42. The system of claim 41 wherein said exact playback time and date is expressed in relation to a common recognized time zone.

43. The system of claim 42 wherein said common recognized time zone is Greenwich Mean Time (GMT).

44. The system of claim 41 wherein said trusted time and date source is an atomic clock maintained by the United States Naval Observatory.

45. The system of claim 41 wherein said trusted time and date source is the internal clock of said instruction file server computer.

46. The system of claim 36 wherein said content file is divided into two or more file segments prior to transmission from said content file server computer to each of said target viewers' client computer and is reassembled upon receipt at said client computer.

47. The system of claim 46 wherein the number and size of said file segments is based on a combination of factors selected from the group of factors consisting of: bandwidth available to said client computer, processing capabilities of said client computer, size of said content file and the level of traffic on said electronic communications network.

48. The system of claim 36 wherein said transmission of said content file server computer to each of said target viewers' client computer takes place asynchronously over a set time period.

49. The system of claim 48 wherein said set time period is based on a combination of factors selected from the group of factors consisting of: bandwidth available to said client computer, processing capabilities of said client computer, size of said content file and the level of traffic on said electronic communications network.

50. The system of claim 36 wherein said content file is displayed to each of said target viewers at said client computer by means of a pre-installed software application compatible with said content file.

51. The system of claim 50 wherein said pre-installed software application is an application selected from the group consisting of: a word processor, a picture viewer, a web browser, a text file viewer, a multimedia player, an mp3 player, a streaming audio player and a streaming video player.

52. The system of claim 36 wherein said content file is stored at each of said target viewers' client computer in an encrypted format.

53. The system of claim 36 wherein said content file is automatically erased from each of said target viewers' client computer after playback.

54. The system of claim 40 wherein:
said exact playback time and date is identical for two or more of said target viewers; and
the internal clock of said two or more target viewer's client computers is synchronized with that of a trusted time and date source;
so that said content file is played back simultaneously at said exact time and date to said two or more target viewers.
